(19) United States
(12) Patent Application Publication
(10) Pub. No.: US 2026/0073818 A1
(43) Pub. Date: Mar. 12, 2026

(54) Panel Connector and Method

(71) Applicant: Coobra Designs, LLC, Elizabethtown, PA (US)

(72) Inventor: Charles T. COOK, Elizabethtown, PA (US)

(21) Appl. No.: 18/883,003

(22) Filed: Sep. 12, 2024

(51) Int. Cl. G09F 9/302; G09F 9/37

(52) U.S. Cl. CPC G09F 9/3026; G09F 9/37

(57) ABSTRACT

A connector and connection arrangement for a joining at least two panels in a display panel system has a resilient connector with a first key and a second key joined thereto by a bridge engaging a primary and secondary aperture in at least two adjacently positioned panels. The connector is configured so that inserting the first key into the primary aperture and rotated the connector to bring the second key toward the secondary aperture engages both keys into the respective apertures to fixedly join the two panels. The bridge provides a handle to allow a user to move the joined panels as well as facilitating removal of the connector during disassembly of the display panel system.

### FIELD OF THE INVENTION

The present disclosure is generally directed to exhibit apparatus and, more particularly, to a connection device for joining adjacent panels in a portable exhibit system having a plurality of modular units.

### BACKGROUND OF THE INVENTION

Display panel systems are widely used in entertainment and performance settings as well as to communicate information relating to education, sales, marketing, and advertising. Such systems are commonly used in a variety of locations, such as trade shows, conventions, conferences, and the like, and even small performance venues. Displays are generally erected for a short period of time and often will be taken down and erected in many different locations. Accordingly, display panel systems that are easy to assemble and disassemble, readily portable, affordable to transport are preferred. Modular systems are further preferred as they are readily configurable in limitless configurations.

Existing display panel systems are commonly cumbersome to transport, erect, and disassemble, incurring unnecessary cost that limits the use of such a system. Traditional wood panels are constructed with plywood or solid lumber and are nailed together. Roto-lock devices are used in wood panels to lock panels together. However, skins are permanently nailed to frames and are belt sanded to fit adjoining panels then they are laminated with a Formica-type laminate. The wood panels are heavy, awkward to handle and are not modular. When a new finish or configuration is desired, old wood frame panels are discarded and new ones are constructed.

Other display panel systems employ metal frames supporting skins. Frames of differing sizes may be provided, but all are typically joined and featuring sliding button/channel system for interconnecting of the panels. In such a system, a button mounted on the post of a first panel slides into the channel of a second panel, fastening the panels at that particular point. Such a structure is known to have limited structural integrity, since the buttons must be free to slide and thus cannot engage the channel in a firm, tight manner.

Recent advances in display panel technology use PVC foam board to create panels and supports structures for displays. The PVC foam board is folded to create three-dimensional members, such as rectangular cross-section beams, which are joined to create larger structures for the display. Fasteners means such as screws, punch clips, and the like, are provided to secure the folded PVS board in a desired configuration. Holes are created in the PVC board where needed to accept the fastening means. Disadvantages of this approach include difficulty in removing the fastening means once the need for the display panel is passed which lead to a general one-time use approach to the display panel system.

What is needed is an improved display panel system and connector system that allows for easy assembly and disassembly of a display panel system. Additional benefits will be realized by a display panel connector system incorporating connectors that can be installed and removed by hand, without the need for tools. Further benefits will be realized by a display panel and connector system incorporating a standardized modular design allowing individual panels to be assembled into modules and modules joined in a variety of configurations to suit the desire display panel configuration. Other features and advantages will be made apparent from the present specification. The teachings disclosed extend to those embodiments that fall within the scope of the claims, regardless of whether they accomplish one or more of the aforementioned needs.

### SUMMARY OF THE INVENTION

In an aspect of the disclosure, a connector is provided for joining two or more panels together as part of a display panel system. The connector includes a first key and a second key joined to the first key by a bridge. The panels to be joined are each provided with a primary aperture and a secondary aperture. The panels positioned to align the respective primary and secondary apertures. The primary apertures are configured so that the first key simultaneously engages opposing ends of the apertures when engaged therein. Spacing between the primary and the secondary aperture is configured so that the second key engages an end closest to the primary aperture when the first key is engaged in the primary aperture.

In an aspect of the disclosure, a connector is provided for joining two or more panels includes a first key and a second key joined to the first key by a bridge. The panels to be joined are each provided with a primary aperture and a secondary aperture configured to simultaneously receive the first and second keys. Retention features provided on the first and second keys retain the key engaged in their respective apertures during use. The connector may be formed from a resilient material allowing flexure to disengage the keys from the apertures and separate the joined panels.

In an aspect, a display panel assembly includes a planar panel board member folded to create a hollow, three-dimensional rectangular prism. The panel board member may include one or more reliefs to facilitate folding the panel board member into three-dimensional configurations. A plurality of uniformly shaped and positioned apertures are provided at least adjacent to the perimeter of the panel board member. Two thicknesses of panel board members may be joined by a connector having a first key and a second key configured to be received in two apertures of the panel boards, the keys extending through the apertures and engaging both panel board thicknesses. The first and second keys may include surfaces and edges configured to engage the panel surfaces adjacent to the apertures and secure the connector in position once inserted. The connector comprises a resilient material allowing the spacing between the first and second keys to be altered by flexure, so that the keys may be repositioned, disengaging the surfaces and edges from the panels surfaces so that the keys may be inserted into or withdrawn from the apertures.

In an aspect of the disclosure, a connector is provided for joining two or more panels includes a first key and a second key joined to the first key by a bridge. The panels to be joined are each provided with a primary aperture and a secondary aperture configured to simultaneously receive the first and second keys. The first key may include an arcuate ramp which contacts a portion of the primary aperture as the first key is inserted therein, rotation of the connector to more the second key toward the secondary aperture causing contact between the arcuate ramp and an edge of the aperture to urge the first key into contact with opposing ends of the primary aperture.

In another aspect of the disclosure, a display panel system includes at least two panels each having a plurality of apertures including at least a primary and a secondary aperture. A panel connector is provided including a first key and a second key joined to the first key by a bridge. The first key has an alignment structure configured to simultaneously align the connector in the primary apertures of the at least two panels when engaged therein, and the second key further comprises an engagement structure configured to simultaneously engage the secondary apertures in the at least two panels and retain the alignment structure simultaneously engaged with the first and second ends of the first apertures and releasably fix the at least two panels in relation to one another.

In another aspect of the disclosure, a display panel system includes at least two panels each having a plurality of apertures including at least a primary and a secondary aperture. The plurality of apertures may be uniformly sized and configured. Each of the plurality of apertures includes a first end and a parallel and oppositely disposed second end spaced apart by a key length. A panel connector is provided including a first key and a second key joined to the first key by a bridge. The first key includes an alignment structure configured to simultaneously align the connector in the primary apertures of at least two panels when engaged therein, and the second key further comprises an engagement structure configured to simultaneously engage the secondary apertures in the at least two panels and retain the alignment structure simultaneously engaged with the first and second ends of the first apertures and releasably fix the at least two panels.

In another aspect of the invention, a display panel system includes at least two panels each having a plurality of apertures including at least a primary and a secondary aperture. The plurality of apertures may be uniformly sized and configured. Each of the plurality of apertures includes a first end and a parallel and oppositely disposed second end spaced apart by a key length. At least one panel includes at least one of the plurality of apertures having a third edge and a fourth edge, the third and fourth edges being oppositely disposed and parallel to each other, spacing between the third and fourth edges being equal to the key length, the third and fourth edges being angled in relation to the first and second edges by an offset angle allowing the at least one panel to be angled in relation to another panel to which it is joined.

In another aspect of the disclosure, a method for joining panels in a display panel system includes providing a first panel having a primary aperture and a spaced apart secondary aperture, providing a second panel having a primary aperture and a spaced apart secondary aperture, and providing a connector having a first key and a second key. The first and second panels are positioned to align respective primary and secondary apertures. A connector is provided having a first key and a second key connected by a bridge. The first key is inserted into into the primary apertures of the first and second panels and the connector rotated to move the second key into engagement with the second apertures to fully engage the first key in the primary apertures of the first and second panels thereby securing the first panel to the second panel. The panels may be separated by disengaging the second key from the secondary apertures by flexing the connector, rotating the connector to move the secondary key away from the secondary apertures, and removing the first key from the primary apertures thereby releasing the first panel from the second panel.

Other features and advantages of the present invention will be apparent from the following more detailed description of the preferred embodiment, taken in conjunction with the accompanying drawings which illustrate, by way of example, the principles of the invention.

### BRIEF DESCRIPTION OF DRAWINGS

The advantages of this invention will be apparent upon consideration of the following detailed disclosure of the invention, especially when taken in conjunction with the accompanying drawings wherein:

FIG. 1 is perspective view of a display panel assembly incorporating aspects of the present invention;

FIG. 2 is a partial perspective view of a panel junction of the type and arrangement in which the present invention is useful;

FIG. 3 is an elevation view of a portion of a display panel junction incorporating aspects of the present invention;

FIG. 4 is an enlarged view of the panel junction showing the configuration of connection apertures in the panels;

FIG. 5 illustrates a panel used in folded arrangement to create a rectangular prism useful for a display panel assembly;

FIG. 6 illustrates the folded panel of FIG. 5 in an intermediate folded configuration;

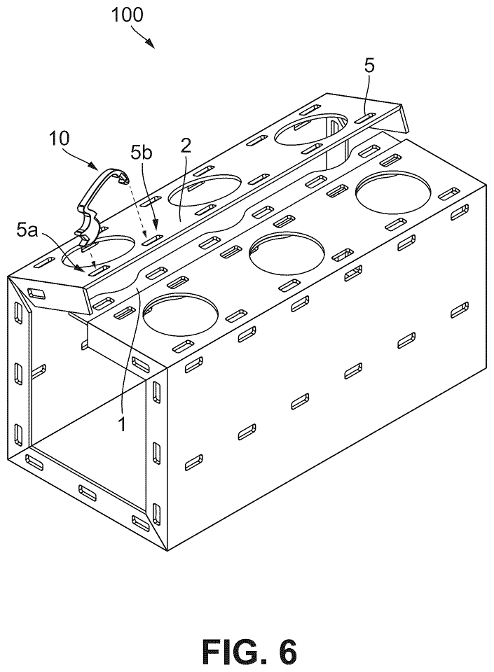

FIG. 7 illustrates the folded panel of FIG. 5 in a complete folded configuration;

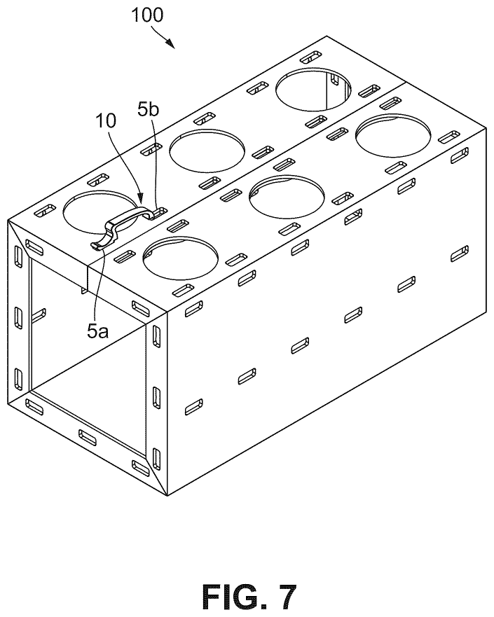

FIG. 8 illustrates an embodiment of a panel clip useful in the display panel assembly;

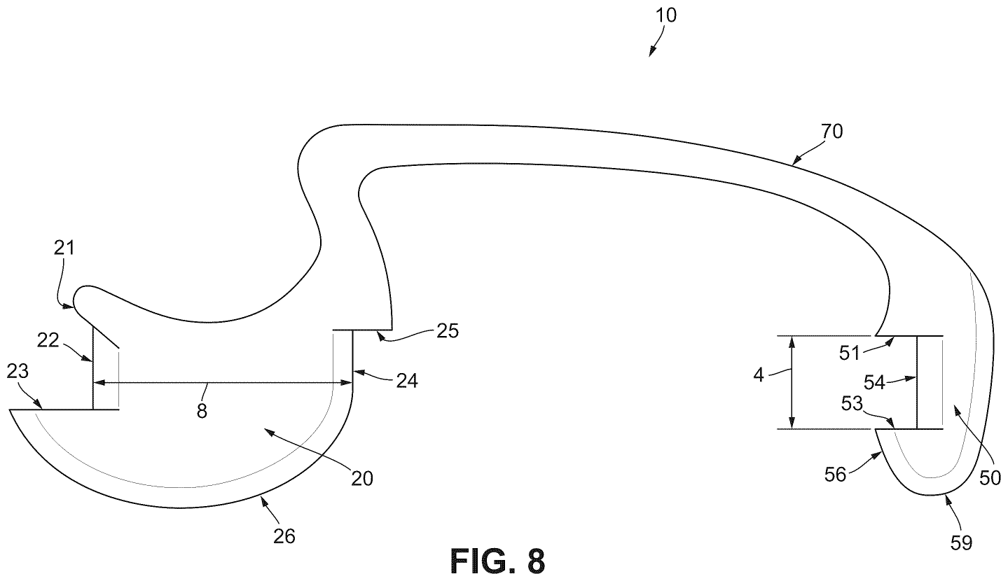

FIG. 9 illustrates an embodiment of a panel clip used for joining three panels

FIG. 10 illustrates an alternate embodiment of connection apertures used in the display panel assembly.

Wherever possible, the same reference numbers will be used throughout the drawings to represent the same parts.

### DETAILED DESCRIPTION OF THE INVENTION

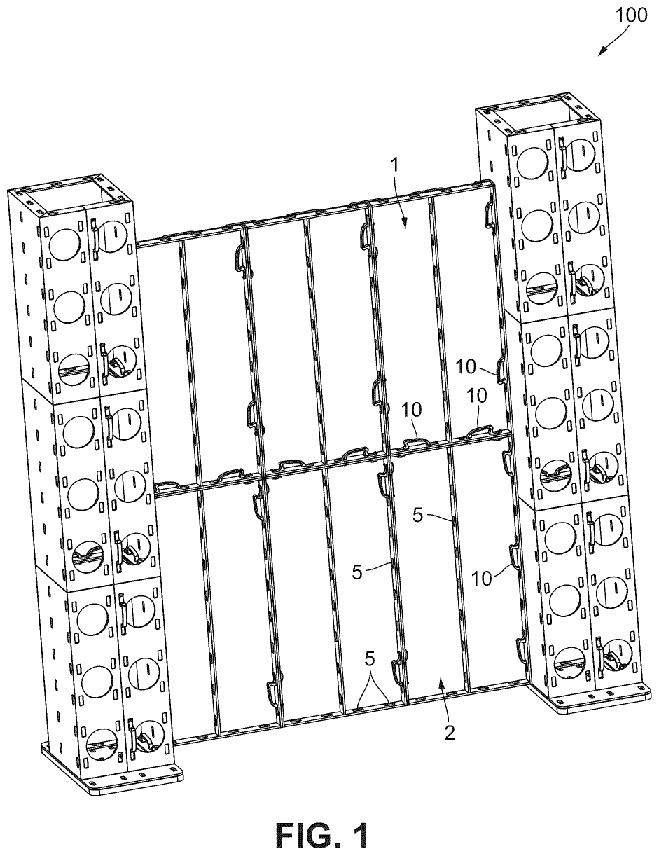

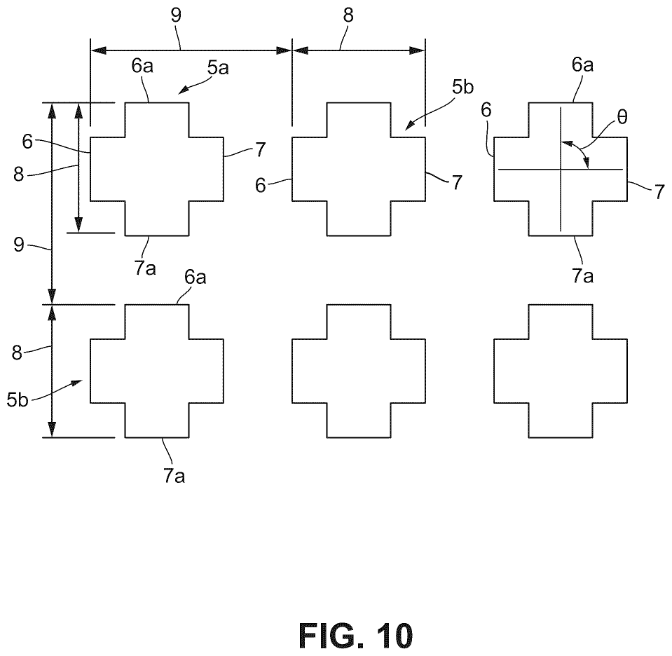

A partial view of a display panel arrangement 100 is illustrated in FIGS. 1 through 4 showing the connection of a first panel 1 and a second panel 2. These panels may be separate individual panels to be joined or portions of a single panel that has been folded or otherwise configured to bring two portions into adjacent contact as shown. A plurality of apertures 5 are provided in the panels. The apertures 5 may be positioned proximate to the perimeter of the panels or at any location in which a connection may be required. The apertures 5 are preferably uniformly configured in size, shape, and relative spacing to create a standardized panel connection arrangement allows the panel boards to be easily assembled in a variety of configurations. One or more of the apertures 5 may be uniquely configured as illustrated in FIG. 10 to allow panels to be joined at different orientations and further improve adaptability of the standard design.

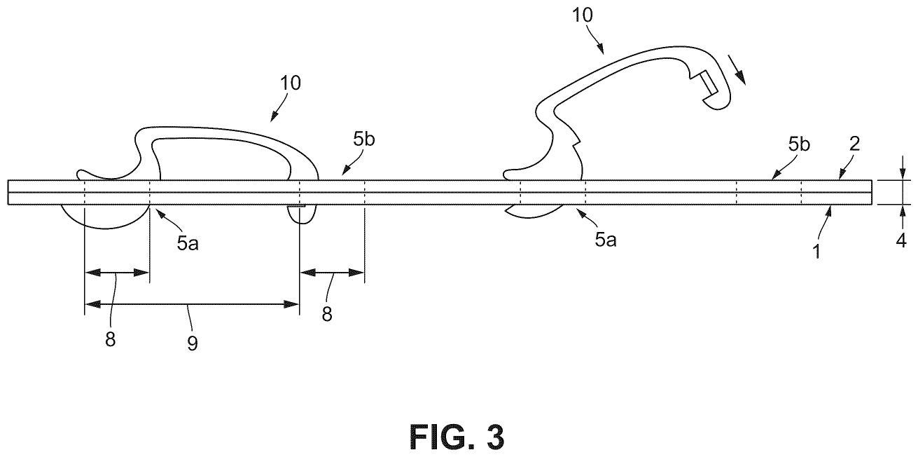

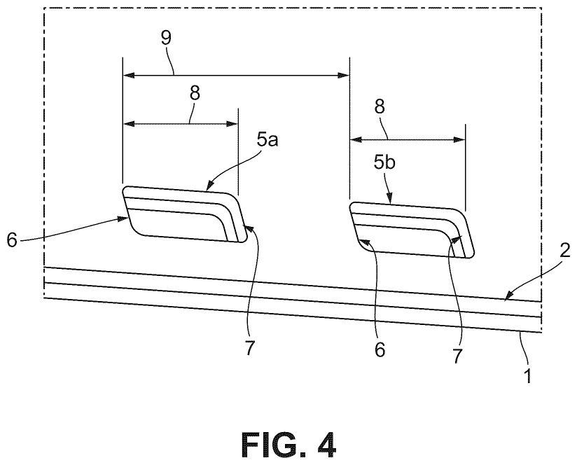

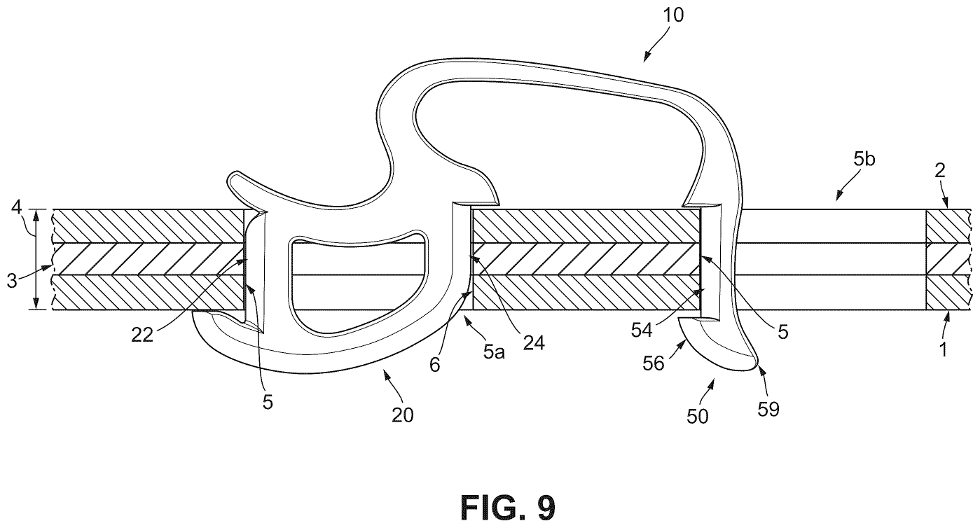

As best illustrated in FIGS. 3 and 4, a connector 10 is selectively engageable in two of the plurality of apertures 5, referred to collectively as engaged apertures and individually as a primary aperture 5a and a secondary aperture 5b. The connector engagement may involve apertures in two or more adjacent panels (layers or thicknesses), the respective panels being arranged to align the apertures and create a generally uniform opening through the stacked panels. FIG. 9 illustrates a panel connection arrangement involving joining a first panel 1, a second panel 2, and a third panel 3. The two of the plurality of apertures engaged by the connector 10 may be adjacent. For installation, the apertures in the panels to be joined must be aligned to form a continuous aperture through the total thickness of the panels.

The plurality of apertures 5 are uniformly configured in size and shape. Each of the apertures includes a first end 6 and a parallel and oppositely disposed second end 7. The distance between the first and second ends of the aperture is defined as the key length 8. The key length 8 may be sized for ease in installation of the connectors while balancing structural integrity of the surrounding panel board. In an embodiment, the key length may range between 25 millimeters (mm) and 75 mm. In an embodiment, the key length may be approximately 50 mm. The width of the apertures may be the same as the key length 8 or it may be less. The minimum width is selected to allow the connector to be received in the apertures.

The plurality of apertures may be uniformly spaced apart in areas of the panels likely to be used for connection to other panels. In an embodiment, the plurality of apertures is aligned in a row adjacent and parallel to an edge of a panel. Interval spacing for adjacent pairs of apertures may be uniform to allow connectors to be installed in one of numerous locations. In an embodiment, the adjacent apertures are positioned on an aperture interval 9 that is greater than the aperture length. In an embodiment the aperture interval 9 may range from 75 mm to 200 mm. In an embodiment, the aperture interval may be approximately 100 mm.

Apertures of different shapes may be provided in the panels to allow connection of adjacent panels in multiple orientations. As best illustrated in FIG. 10, apertures may include a third end 6a and a fourth end 7a which are opposingly disposed and parallel to each other. The third end 6a and the fourth end 7a are spaced apart by the key length 8, the same as the spacing between the first and second ends. The third and fourth ends 6a, 7a may be angled in relation to the first and second ends 6, 7 to permit adjacent panels to be joined in an angled relation to each other, defined as an offset angle ⊖. The offset angle ⊖ may be measured as the angle between a first axis extending perpendicularly between the first and second ends 6, 7, and a second axis extending perpendicularly between the third and fourth ends 6a, 7a. The offset angle may range from 15 degrees to 90 degrees. In an embodiment, the offset angle ⊖ may be selected from among the list of 15 degrees, 30 degrees, 45 degrees, and 90 degrees.

Each connector 10 includes a first key 20 and a second key 50 which is joined to the first key 20 by a bridge 70. The first key 20 is configured to be received by the primary aperture 5a and simultaneously engage (contact) a first end 6 and a second end 7 of the primary aperture when the connector 10 is fully installed. The second key 50 is received by the secondary aperture 5b but is configured to engage only a first end 6 in the secondary aperture when the connector 10 is fully installed.

The connector 10 may be constructed from resilient material to permit flexure to allow the first and second keys to be engaged in the primary and secondary apertures 5a, 5b, and remain snugly engaged once the connector 10 reaches its fully installed position with respect to the panels. The bridge 70 may be further configured to manage the resilient flexibility of the connector and optimize installation and removal. The bridge 70 may be configured to provide a convenient handle for a user to grasp and move the joined panels.

The first key 20 further includes an exterior surface 22 and an interior surface 24 engageable with a primary aperture 5a in a panel. When the connector is fully installed, the exterior surface 22 is in adjacent contact with the first end 6 and the interior surface 24 is in adjacent contact with the second end 7. The second key 50 includes an interior surface 54 engageable with a first end 8 of the secondary aperture 5b. The second key 50 interior surface 54 is in adjacent contact with the first end 6 of the secondary aperture 5b when the connector 10 is fully installed (see FIG. 3).

The key length 8 of the first key 20, spacing between the exterior surface 22 and the interior surface 24 is established to match the key length of the panel apertures for which it is intended. The key length of the first key 20 and the key length of an aperture may be approximately the same, with small differences to allow the first key to fit within the aperture. In an embodiment, the key length of the first key may be up to 5% less than the key length of the aperture. The exterior surface 22 and the interior surface 24 may be contoured to improve installation and removal. In an embodiment, the exterior and interior surfaces may be convexly contoured.

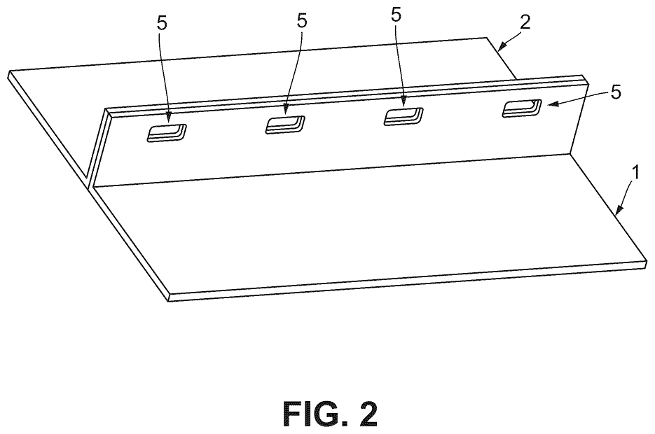

The key depth 4 is established by the thickness of the panels to be joined and the number of panel layers, and is measured from the planar surfaces adjacent to the apertures. The key depth 4 for the connector is established by stop structures adjacent to the exterior surface 22 and interior surface 24. The exterior surface 22 is bounded by an outer stop 21 and an inner stop 23 which extend outwardly away from the exterior surface 22. The inner stop 23 may be oriented generally perpendicular to the exterior surface so that it will be positioned in adjacent contact with the surface of the innermost panel (first panel 1 in FIGS. 2 and 3) when fully installed. The outer stop 21 may be positioned adjacent to the surface of the outermost panel (second panel 2 in FIGS. 2 and 3) when fully installed. Outer stop 21 may be angled in relation to the outer panel surface to facilitate installation and removal of the clip 10 and to minimize panel damage during installation and removal.

The interior surface 24 is includes an outer stop 25. In place of an inner stop, the interior surface 24 adjoins an engagement ramp 26 which is configured to facilitate installation of the clip. The engagement ramp may be a convexly arcuate surface. The transition between the engagement ramp and the interior surface may be smooth, without any discontinuities so that rotating the clip 10 as it is installed causes the engagement ramp to interact with the second end 7 of the primary aperture 5a and urge the exterior surface 22 into contact with the first end 6. The outer ledge 25 of the interior surface 24 limits the rotation of the clip 10; when connector 10 is rotated to the fully installed orientation, the outer ledge 25 is in adjacent contact with the surface of the outermost panel 2, inhibiting further rotation of the connector 10.

The second key 50 includes an interior surface 54 which is arranged on the connector 10 to contact a first end 6 of the secondary aperture 5b when the connector is fully installed. The spacing between the exterior surface 22 of the first key 20 and the interior surface 54 of the second key 50 is approximately equal to the aperture interval spacing dimension of the panels on which the connector is used. The connector key spacing may be up to 5% less than the aperture interval spacing of the panels. The connector spacing should not exceed the aperture interval spacing dimension of the panels so that the connector is slightly flexed when fully installed to maintain the connector snugly connected to the panels. The second key interior surface 54 is bounded by an outer stop 51 and an inner stop 53 which extend away from the interior surface 54, generally toward the first key 20. The inner and outer stops 51, 53 of the second key interior surface 54 are preferably parallel to the surface of the innermost and outermost panels and in adjacent contact therewith so that, when engaged, the inner and outer stops 51, 53 to secure the connector 10 in a generally fixed position and limit rotational movement of the connector in both the installation and removal directions.

The first and second keys 25, 50 are configured with a key depth 4 to extend through apertures in at least two adjacently positioned panels or thickness of a folded panel. In an embodiment, the keys may be configured to join three adjacent panels. Panels made from PVC foam board are known in the art and selected for light weight, structural strength and low cost. Panel thicknesses may range from 3 mm to as much as 30 mm. Display panel systems of the type in which the present invention is ideally used may range from 3 mm to 18 mm. Panel thicknesses in the range of 6 mm to 12 mm in thickness are commonly employed. Connectors having commonly used key depths may be provided. In an embodiment, connectors may have a key depth 4 ranging from 6 mm to 60 mm. In an embodiment, connectors may have a key depth 4 ranging from 12 mm to 36 mm. In an embodiment, connectors have a key depth 4 selected from of the list of 12 mm, 18 mm, and 36 mm. Panels of other materials may also be joined using the disclosed invention.

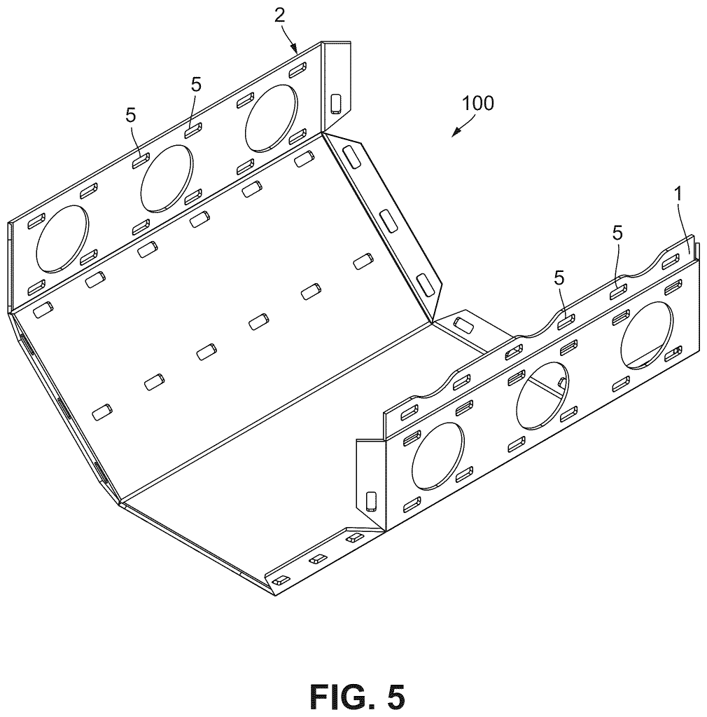

Joining the panels is accomplished by aligning the panels 1, 2 to be joined so that at least two apertures 5, a primary aperture 5a and a secondary aperture 5b, are aligned. The panels to be joined may be individual panels used to create a larger display panel assembly (see FIG. 1). The panels to be joined may be different portions of a single panel that has been folded to create a shape, such as a rectangular prism (see FIG. 5 - 7) or other configurations suited for display panel assemblies.

Once the panels are positions to align at least a primary and secondary aperture 5a, 5b, a connector 10 is engaged, first by angling the connector in relation to the panel surface and inserting first key 20 into the primary aperture 5a. Rotating the connector causes engagement ramp 26 to contact second end 7 of the primary aperture 5a and shift the connector as rotation continues so that the exterior surface 22 of the first key 20 abuts the first end 6 of the primary aperture 5a. During this rotation, the second key 50 moves toward the secondary aperture 5b and engages the aperture as the connector approached its fully installed orientation. Flexure of the connector, particularly bridge 70, allows the inner stop 53 of the second key 50 to be outwardly displaced by contact with the first end 6 of the secondary aperture 5b until the second key 50 is fully engaged in the secondary aperture 5b. The distal end 59 of the second key externally adjacent to the inner ledge may include an engagement ramp 56 configured to contact the first end 8 of the secondary aperture and urge the second key 50 outwardly to allow engagement. The distal end 59 may further be configured by extending beyond the panel surface to allow a user to apply pressure to the distal end and deflect the second key 50 to release the key from engagement with the secondary aperture 5b. Once the second key is deflected to disengage the inner sop 53 from the aperture end, the connector may be rotated oppositely from the direction for installation and disengaged from the panel assembly.

In addition to securing the connected panels together, the bridge 70 of the installed connectors 5 also provides a convenient hand-hold a user have grasp to manipulate the assembled panel assembly.

While the exemplary embodiments illustrated in the figures and described herein are presently preferred, it should be understood that these embodiments are offered by way of example only. Accordingly, the present application is not limited to a particular embodiment, but extends to various modifications that nevertheless fall within the scope of the appended claims. The order or sequence of any processes or method steps may be varied or re-sequenced according to alternative embodiments.

References herein to the terms “up” or “down,” or “top” or “bottom” are used as a matter of mere convenience and are determined with reference to the ground. Furthermore, the various components shown or described herein for any specific application of this invention can be varied or altered as anticipated by this invention and the practice of a specific application of any element may already be widely known or used in the art by persons skilled in the art and each will likewise not therefore be discussed in significant detail.

It is important to note that the construction and arrangement of the various exemplary embodiments is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited in the claims. For example, elements shown as integrally formed may be constructed of multiple parts or elements, the position of elements may be reversed or otherwise varied, and the nature or number of discrete elements or positions may be altered or varied. Accordingly, all such modifications are intended to be included within the scope of the present application. The order or sequence of any process or method steps may be varied or re-sequenced according to alternative embodiments. In the claims, any means-plus-function clause is intended to cover the structures described herein as performing the recited function and not only structural equivalents but also equivalent structures. Other substitutions, modifications, changes and omissions may be made in the design, operating conditions and arrangement of the exemplary embodiments without departing from the scope of the present application.

1. A connector for a modular display panel system comprising:
a first key; and
a second key joined to the first key by a bridge;
wherein the first key further comprises an alignment structure configured to align the connector in a primary aperture in a panel when engaged therein, and the second key further comprises an engagement structure configured to releasably engage a secondary aperture in the panel and retain the alignment structure engaged in the primary aperture.

2. The connector of claim 1, wherein the alignment structure of the first key includes an interior and an exterior surface engageable in the primary aperture, and the engagement structure of the second key includes an interior surface engageable in the secondary aperture.

3. The connector of claim 2, wherein the interior and exterior surfaces of the first key are engageable with a first end and a second end, respectively, in the primary aperture.

4. The connector of claim 2, wherein the interior surface of the second key is engageable with a first end of the secondary aperture when the alignment structure is engaged in the primary aperture.

5. The connector of claim 2, further comprising an arcuate ramp adjacent to the first interior surface configured to urge the first exterior surface into contact with the second end as the connector is rotated.

6. The connector of claim 1, wherein the first key further comprises a retention structure configured to limit movement of the first key in a direction normal to the panel through which the primary aperture extends when the first key is engaged in the primary aperture.

7. The connector of claim 6, wherein the retention structure includes an inner stop and an outer stop, the inner and outer stops configured to be positioned in adjacent contact with the panel adjacent to the primary aperture when the second key is engaged the secondary aperture.

8. The connector of claim 1, wherein the connector comprises a resilient material.

9. The connector of claim 8, wherein the second key further comprises a release configured to enable selective disengagement of the second key from the secondary aperture by a flexure of the connector.

10. A connection arrangement for a connecting at least two panels in a display panel system comprising:
a first panel and a second panel, each having a plurality of uniformly sized apertures including at least a primary aperture and a secondary aperture, each aperture including a first end and a parallel and oppositely disposed second end spaced apart by a key length;
a connector having a first key and a second key joined thereto by a bridge, the connector being formed from a resilient material;
wherein the first key further comprises an alignment structure configured to simultaneously align the connector in the primary apertures of first and second panels when engaged therein, and the second key further comprises an engagement structure configured to simultaneously engage the secondary apertures in the first and second panels and retain the alignment structure simultaneously engaged with the first and second ends of the first apertures and releasably fix the first panel in relation to the second panel.

11. The connection arrangement of claim 10, wherein the first key is engageable in the primary apertures of the first and second panels by rotating movement of the connector to bring the second key into engagement with the secondary apertures.

12. The connection arrangement of claim 10, wherein the first key further comprises an interior surface configured for adjacent contact with the end of the primary apertures of the first and second panels, and an exterior surface configured for adjacent contact with the respective second ends of the primary apertures when the first key is fully engaged in the primary apertures.

13. The connection arrangement of claim 12, wherein the first key further comprises an arcuate ramp adjacent to the first interior surface configured to urge the first exterior surface into contact with the second end as the connector is rotated to bring the second key into engagement with the secondary apertures.

14. The connection arrangement of claim 10, wherein the first key further comprises a retention structure configured to limit movement of the first key in a direction normal to the panels through which the apertures extend when the first key is engaged in the primary aperture.

15. The connection arrangement of claim 10, wherein the second key further comprises a release configured to enable selective disengagement of the second key from the secondary aperture by a flexure of the connector thereby enabling disengagement of the second key from the secondary apertures, rotation of the connector to disengage the first key from the primary apertures, and separation of the connector from the at least two panels.

16. The connection arrangement of claim 10, wherein the key length ranges between 25 millimeters and 75 millimeters.

17. The connection arrangement of claim 10, wherein adjacent pairs of apertures in the plurality of apertures are uniformly spaced by an aperture interval.

18. The connection of claim 17, wherein the aperture interval is greater than the key length.

19. The connection of claim 18, wherein the aperture interval is 100 millimeters.

20. The connection arrangement of claim 10, wherein at least one of the plurality of apertures comprises a third edge and a fourth edge, the third and fourth edges being oppositely disposed and parallel to each other, spacing between the third and fourth edges being equal to the key length, the third and fourth edges being angled in relation to the first and second edges by an offset angle.

21. The connection arrangement of claim 17, wherein the offset angle ranges from 15 degrees to 90 degrees.

22. A method for joining panels in a display panel system comprising the steps of:
providing a first panel having a primary aperture and a spaced apart secondary aperture;
providing a second panel having a primary aperture and a spaced
apart secondary aperture;
providing a connector having a first key and a second key;
positioning the first panel and the second panel to align respective primary and secondary apertures;
inserting the first key into the primary apertures of the first and second panels; and
rotating the connector to move the second key into engagement with the second apertures to fully engage the first key in the primary apertures of the first and second panels thereby securing the first panel to the second panel.

23. The method of claim 22, further comprising the steps of:
disengaging the second key from the secondary apertures by flexing the connector;
rotating the connector to move the secondary key away from the secondary apertures; and
removing the first key from the primary apertures thereby releasing the first panel from the second panel.
